(19) United States
(12) Patent Application Publication
(10) Pub. No.: US 2017/0026648 A1
(43) Pub. Date: Jan. 26, 2017

(54) HYBRID VIDEO DECODER AND ASSOCIATED HYBRID VIDEO DECODING METHOD

(71) Applicant: MEDIATEK INC., Hsin-Chu (TW)

(72) Inventors: Ming-Long Wu, Taipei City (TW); Sheng-Jen Wang, Tainan City (TW); Chia-Yun Cheng, Hsinchu County (TW); Yu-Cheng Chu, Hsinchu City (TW); Hao-Chun Chung, Hsinchu County (TW); Shen-Kai Chang, Hsinchu County (TW); Yung-Chang Chang, New Taipei City (TW)

(21) Appl. No.: 15/209,774

(22) Filed: Jul. 14, 2016

Related U.S. Application Data
(60) Provisional application No. 62/196,328, filed on Jul. 24, 2015.

(51) Int. Cl. H04N 19/13; H04N 19/44; H04N 19/42; H04N 19/176

(52) U.S. Cl. CPC H04N 19/13; H04N 19/176; H04N 19/44; H04N 19/42

(57) ABSTRACT

A hybrid video decoder has a hardware decoding circuit, a software decoding circuit, and a meta-data access system. The hardware decoding circuit deals with a first portion of a video decoding process for at least a portion of a frame, wherein the first portion of the video decoding process includes entropy decoding. The software decoding circuit deals with a second portion of the video decoding process. The meta-data access system manages meta data transferred between the hardware decoding circuit and the software decoding circuit.

### CROSS REFERENCE TO RELATED APPLICATIONS

This application claims the benefit of U.S. provisional application No. 62/196,328, filed on Jul. 24, 2015 and incorporated herein by reference.

### BACKGROUND

The present invention relates to a video decoder design, and more particularly, to a hybrid video decoder and an associated hybrid video decoding method.

The conventional video coding standards generally adopt a block based coding technique to exploit spatial and temporal redundancy. For example, the basic approach is to divide the whole source frame into a plurality of blocks, perform prediction on each block, transform residuals of each block, and perform quantization, scan and entropy encoding. Besides, a reconstructed frame is generated in an internal decoding loop of the video encoder to provide reference pixel data used for coding following blocks. For example, inverse scan, inverse quantization, and inverse transform may be included in the internal decoding loop of the video encoder to recover residuals of each block that will be added to predicted samples of each block for generating a reconstructed frame. A video decoder is arranged to perform an inverse of a video encoding process performed by a video encoder. For example, a typical video decoder includes an entropy decoding stage and subsequent decoding stages.

Software-based video decoders are widely used in a variety of applications. However, concerning a conventional software-based video decoder, the entropy decoding stage is generally a performance bottleneck due to high dependency of successive syntax parsing, and is not suitable for parallel processing. Thus, there is a need for an innovative video decoder design with improved decoding efficiency.

### SUMMARY

One of the objectives of the claimed invention is to provide a hybrid video decoder and an associated hybrid video decoding method.

According to a first aspect of the present invention, an exemplary hybrid video decoder is disclosed. The exemplary hybrid video decoder includes a hardware decoding circuit, a software decoding circuit, and a meta-data access system. The hardware decoding circuit is arranged to deal with a first portion of a video decoding process for at least a portion of a frame, wherein the first portion of the video decoding process comprises entropy decoding. The software decoding circuit is arranged to deal with a second portion of the video decoding process. The meta-data access system is arranged to manage meta data transferred between the hardware decoding circuit and the software decoding circuit.

According to a second aspect of the present invention, an exemplary hybrid video decoding method is disclosed. The exemplary hybrid video decoding method includes: performing hardware decoding to deal with a first portion of a video decoding process for at least a portion of a frame, wherein the first portion of the video decoding process comprises entropy decoding; performing software decoding to deal with a second portion of the video decoding process; and managing meta data transferred between the hardware decoding and the software decoding.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a hybrid video decoder according to an embodiment of the present invention.

FIG. 2 is a diagram illustrating a first exemplary design of a meta-data access system in FIG. 1 according to an embodiment of the present invention.

FIG. 3 is a flowchart illustrating a control method employed by a controller in FIG. 2 according to an embodiment of the present invention.

FIG. 4 is a diagram illustrating a hybrid video decoder with a frame level pipeline according to an embodiment of the present invention.

FIG. 5 is a diagram illustrating meta-data storages used by the frame level pipeline according to an embodiment of the present invention.

FIG. 6 is a diagram illustrating a hybrid video decoder with a macroblock (MB) level pipeline according to an embodiment of the present invention.

FIG. 7 is a diagram illustrating meta-data storages used by the MB level pipeline according to an embodiment of the present invention.

FIG. 8 is a diagram illustrating a hybrid video decoder with a slice level pipeline according to an embodiment of the present invention.

FIG. 9 is a diagram illustrating meta-data storages used by the slice level pipeline according to an embodiment of the present invention.

FIG. 10 is a diagram illustrating a hybrid video decoder with a single meta-data storage shared by a hardware decoding part for hardware decoding of any frame and a software decoding part for software decoding of any frame according to an embodiment of the present invention.

FIG. 11 is a diagram illustrating a second exemplary design of the meta-data access system shown in FIG. 1 according to an embodiment of the present invention.

FIG. 12 is a flowchart illustrating a control method employed by a controller in FIG. 11 according to an embodiment of the present invention.

FIG. 13 is a diagram illustrating a hybrid video decoder with another frame level pipeline according to an embodiment of the present invention.

FIG. 14 is a diagram illustrating meta-data storages used by another frame level pipeline according to an embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

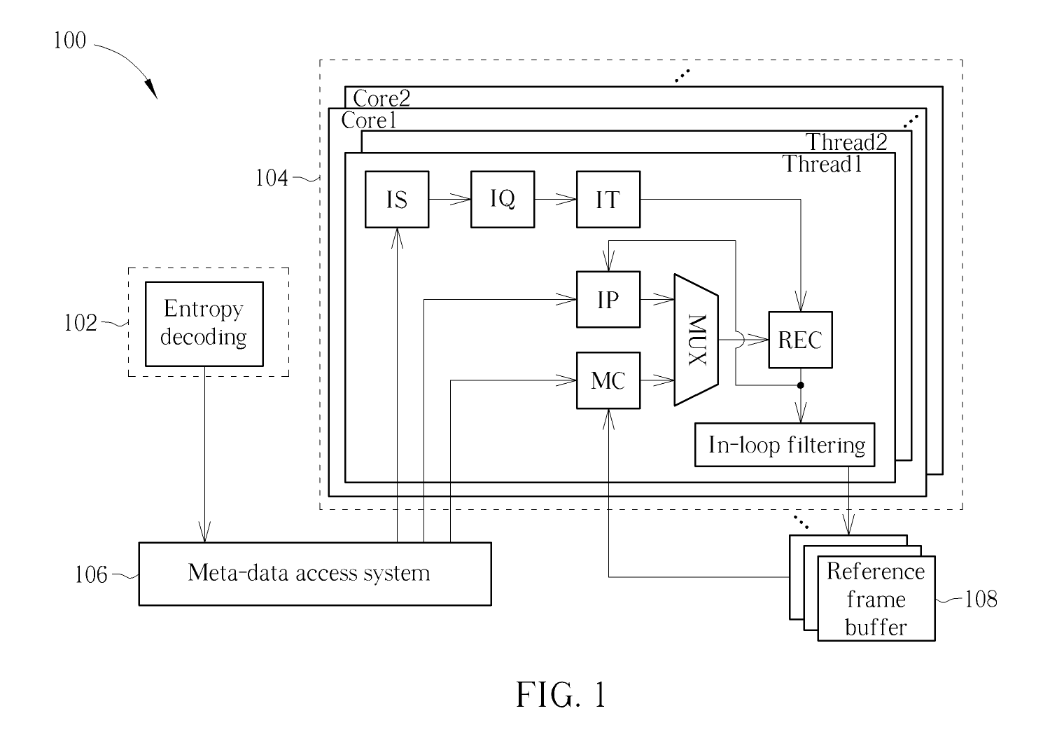

FIG. 1 is a diagram illustrating a hybrid video decoder according to an embodiment of the present invention. The hybrid video decoder 100 may be part of an electronic device. The hybrid video decoder 100 includes a plurality of circuit elements, such as a hardware decoding part 102, a software decoding part 104, a meta-data access system 106, and one or more reference frame buffers 108. In one exemplary design, the hardware decoding part 102 may be implemented by a dedicated decoding circuit arranged to perform a first portion of a video decoding process for at least a portion (i.e., part or all) of a frame, and the software decoding part 104 may be implemented by a multi-thread multi-core processor system arranged to perform a second portion of the video decoding process for at least a portion (i.e., part or all) of the frame. For example, the software decoding part 104 may be a central processing unit (CPU) system, a graphics processing unit (GPU) system, or a digital signal processor (DSP) system. To put it simply, the hardware decoding part 102 is a hardware decoding circuit responsible for hardware decoding (which is performed based on pure hardware), and the software decoding part 104 is a software decoding circuit responsible for software decoding (which is performed based on software execution).

The video decoding process may be composed of a plurality of decoding functions, including entropy decoding, inverse scan (IS), inverse quantization (IQ), inverse transform (IT), intra prediction (IP), motion compensation (MC), intra/inter mode selection (MUX), reconstruction (REC), in-loop filtering (e.g., deblocking filtering), etc. The filtered samples of a current frame are generated from the in-loop filtering to the reference frame buffer 108 to forma reference frame that will be used by the motion compensation to generate predicted samples of a next frame. The first portion of the video decoding process includes at least the entropy decoding function, and the second portion of the video decoding process includes the rest of the decoding functions of the video decoding process.

As shown in FIG. 1, the hardware entropy decoding is performed by the hardware decoding part 102, and subsequent video decoding is performed by the software decoding part 104 (e.g., a CPU/GPU/DSP system executing a decoding program to perform the subsequent software decoding according to an output of the hardware entropy decoding). However, this is for illustrative purposes only, and is not meant to be a limitation of the present invention. Under the premise of ensuing that entropy decoding is performed by the hardware decoding part 102, any hybrid decoding design with a video decoding process partitioned into a hardware-based decoding process and a software-based decoding process may be employed by the proposed hybrid video decoder 100. For example, in an alternative design, the hardware decoding part 102 may be configured to perform hardware decoding including entropy decoding and at least one of the subsequent decoding operations such as IS, IQ, IT, IP, and MC. This also falls within the scope of the present invention.

Since the software decoding part 104 may be implemented by a multi-thread multi-core processor system, parallel processing can be achieved. As shown in FIG. 1, the software decoding part 104 includes multiple processor cores (e.g., Core1 and Core2), each being capable of running multiple thresholds (e.g., Thread1 and Thread2). The threads concurrently running on the same processor core or different processor cores may deal with different frames or may deal with different portions (e.g., macroblocks, tiles, or slices) in a same frame. However, this is for illustrative purposes only, and is not meant to be a limitation of the present invention. In one alternative design, the software decoding part 104 may be implemented by a single-thread multi-core processor system or a multi-thread single-core processor system. To put it simply, the present invention has no limitations on the number of processor cores and/or the number of concurrent threads supported by each processor core.

Compared to the software entropy decoding, the hardware entropy decoding performed by dedicated hardware has better entropy decoding efficiency. Hence, compared to the typical software-based video decoder, the hybrid video decoder 100 proposed by the present invention is free from the performance bottleneck resulting from the software-based entropy decoding. In addition, the subsequent software decoding, including intra/inter prediction, reconstruction, in-loop filtering, etc., can benefit from parallel processing capability of the processor system. Hence, a high-efficient video decoding system is achieved by the proposed hybrid video decoder design.

The hardware decoding part 102 may write meta data (i.e., intermediate decoding result) into the meta-data access system 106, and the software decoding part 104 may read the meta data (i.e., intermediate decoding result) from the meta-data access system 106 and then process the meta data (i.e., intermediate decoding result) to generate a final decoding result. In this embodiment, the first portion of the video decoding process includes entropy decoding, and the second portion of the video decoding process includes the subsequent decoding operations. Hence, the hardware entropy decoding performed by the hardware decoding part 102 may write meta data (i.e., intermediate decoding result) into the meta-data access system 106 by using a dedicated data structure, and the subsequent software decoding performed by the software decoding part 104 may read the dedicated data structure from the meta-data access system 106, parse the dedicated data structure to obtain the meta data (i.e., intermediate decoding result), and process the obtained meta data (i.e., intermediate decoding result) to generate a final decoding result. For example, the meta data generated from entropy decoding may include residuals to be processed by IS performed at the software decoding part 104, intra mode information to be referenced by IP performed at the software decoding part 104, and inter mode and motion vector (MV) information to be referenced by MC performed at the software decoding part 104.

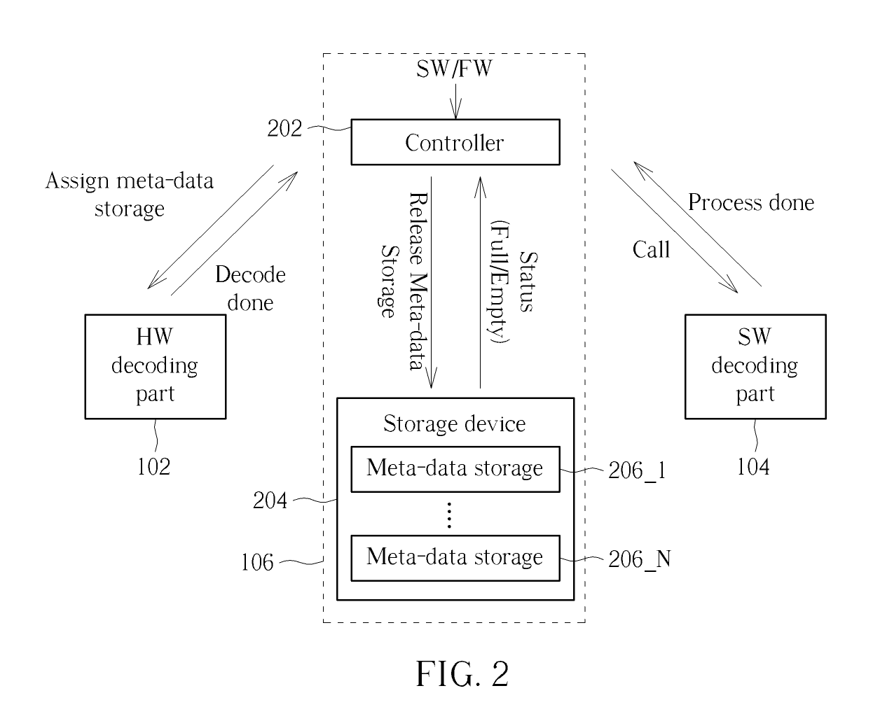

As shown in FIG. 1, an output of the hardware decoding part 102 is written into the meta-data access system 106, and an input of the software decoding part 104 is read from the meta-data access system 106. Hence, the meta-data access system 106 should be properly designed to manage meta-data write and meta-data read for managing the meta data transferred from the hardware decoding part 102 to the software decoding part 104. FIG. 2 is a diagram illustrating a first exemplary design of the meta-data access system 106 shown in FIG. 1 according to an embodiment of the present invention. The meta-data access system 106 includes a controller 202 and a storage device 204. The storage device 204 is arranged to store meta data transferred between the hardware (HW) decoding part 102 and the software (SW) decoding part 104 of the hybrid video decoder 100. As mentioned above, the hardware decoding part 102 is arranged to deal with a first portion of a video decoding process, and the software decoding part 104 is arranged to deal with a second portion of the video decoding process. The storage device 204 may be implemented using a single storage unit (e.g., a single memory device), or may be implemented using multiple storage units (e.g., multiple memory devices). In other words, a storage space of the storage device 204 may be a storage space of a single storage unit, or may be a combination of storage spaces of multiple storage units. In addition, the storage device 204 may be an internal storage device such as a static random access memory (SRAM) or flip-flops, may be an external storage device such as a dynamic random access memory (DRAM), a flash memory, or a hard disk, or may be a mixed storage device composed of internal storage device (s) and external storage device (s).

In this embodiment, the storage space of the storage device 204 may be configured to have one or more meta-data storages 206_1-206_N allocated therein, where N is a positive integer and N≧1. Each of the meta-data storages 206_1-206_N has an associated status indicator indicating whether the meta-data storage is available (e.g., empty) or unavailable (e.g., full). When a status indicator indicates that an associated meta-data storage is available (e.g., empty), it means the associated meta-data storage can be used by the HW decoding part 102. When the status indicator indicates that the associated meta-data storage is unavailable (e.g., full), it means the associated meta-data storage is already written by the HW decoding part 102 to have meta data needed to be processed by the SW decoding part 104, and is not available to the HW decoding part 102 for storing more HW generated meta data.

The controller 202 is arranged to manage the storage space of the storage device 204 according to at least one of an operation status of the hardware decoding part 102 and an operation status of the software decoding part 104. By way of example, but not limitation, the controller 202 may load and execute software SW or firmware FW to achieve the intended functionality. In this embodiment, the controller 202 is able to receive a “Decode done” signal from the HW decoding part 102, receive a “Process done” signal from the SW decoding part 104, generate an “Assign meta-data storage” command to assign an available meta-data storage to the HW decoding part 102, generate a “Call” command to trigger the SW decoding part 104 to start SW decoding, and generate a “Release meta-data storage” command to the storage device 204 to make an unavailable meta-data storage with a status indicator “unavailable/full” become an available meta-data storage with a status indicator “available/empty”.

The controller 202 is capable of monitoring a status indicator of each meta-data storage allocated in the storage device 204 to properly manage the storage device 204 accessed by the HW decoding part 102 and the SW decoding part 104. Further details of the controller 202 are described as below.

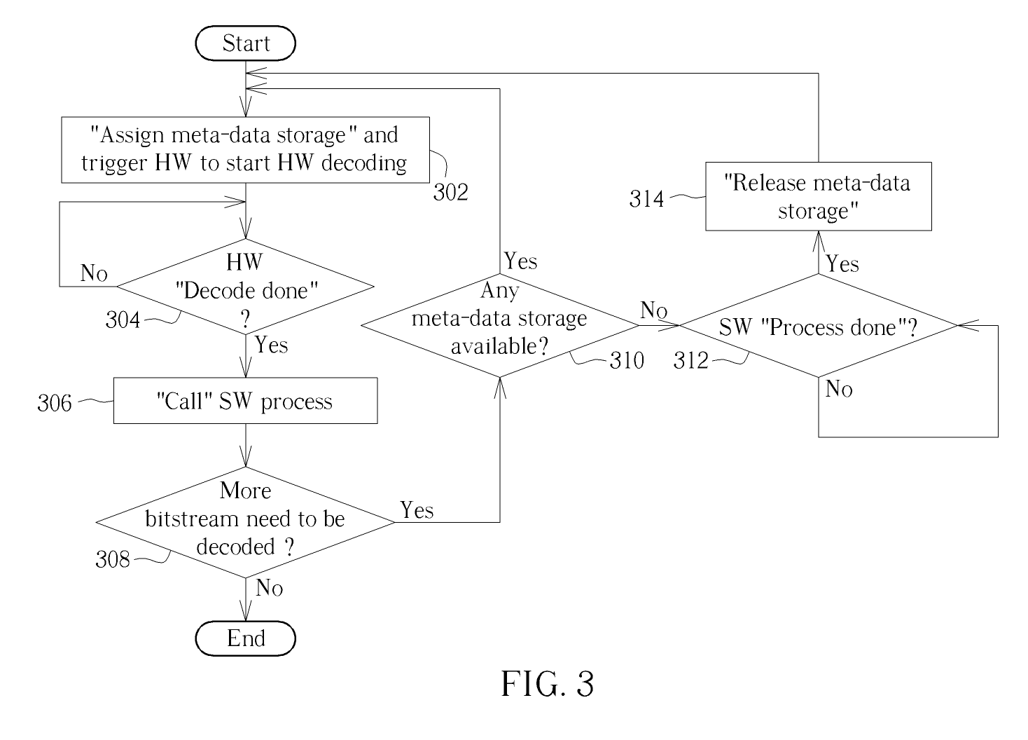

FIG. 3 is a flowchart illustrating a control method employed by the controller 202 in FIG. 2 according to an embodiment of the present invention. Provided that the result is substantially the same, the steps are not required to be executed in the exact order shown in FIG. 3. Initially, each of the meta-data storages 206_1-206_N (N 1) allocated in the storage device 204 has a status indicator “available/empty”. Hence, in step 302, the controller 202 assigns a first meta-data storage (which is an available meta-data storage selected from meta-data storages 206_1-206_N) to the HW decoding part 102, and triggers the HW decoding part 102 to start the HW decoding (i.e., first portion of video decoding process) for at least a portion of a current frame (e.g., one frame, one MB, one tile, or one slice). After the first portion of the video decoding process is started, the HW decoding part 102 generates meta data to the first meta-data storage assigned by the controller 202. In step 304, the controller 202 checks if the first portion of the video decoding process is done. For example, the controller 202 checks if a “Decode done” signal is generated by the HW decoding part 102. If the “Decode done” signal is received by the controller 202, the flow proceeds with step 306; otherwise, the controller 202 keeps checking if the first portion of the video decoding process is done. It should be noted that, when the first portion of the video decoding process is performed or after the first portion of the video decoding process is done, the first meta-data storage assigned by the controller 202 is set to have a status indicator “unavailable/full”. That is, since the first meta-data storage has the meta data waiting to be processed by the subsequent SW decoding, the first meta-data storage becomes an unavailable meta-data storage for the controller 202.

In step 306, the controller 202 instructs the SW decoding part 104 to start the subsequent SW decoding (i.e., second portion of video decoding process) for at least a portion of the current frame (e.g., one frame, one MB, one tile, or one slice). Hence, the HW generated meta data in the first meta-data storage are read by the SW decoding part 104 and processed by the subsequent SW decoding at the SW decoding part 104. It should be noted that step 306 is a task that can be executed at any timing in the flowchart when the meta data in one meta-data storage are ready for subsequent SW decoding.

In step 308, the controller 202 checks if there are more bitstream data (e.g., more frames, more MBs, more tiles, or more slices) needed to be decoded. If no, the control method is ended; otherwise, the flow proceeds with step 310. In step 310, the controller 202 checks if the storage device 204 has any meta-data storage with a status indicator “available/empty”. If yes, the flow proceeds with step 302, and the controller 202 assigns a second meta-data storage (which is an available meta-data storage selected from meta-data storages 206_1-206_N) to the HW decoding part 102, and triggers the HW decoding part 102 to start the HW decoding for a next frame or to start the HW decoding for a portion of a frame (e.g., the next MB/tile/slice in the current frame or the leading MB/tile/slice in the next frame).

If step 310 finds that the storage device 204 has no meta-data storage with a status indicator “available/empty” now, the flow proceeds with step 312. In step 312, the controller 202 checks if the second portion of the video decoding process is done. For example, the controller 202 checks if a “Process done” signal is generated by the SW decoding part 104. If the “Process done” signal is received by the controller 202, the flow proceeds with step 314; otherwise, the controller 202 keeps checking if the second portion of the video decoding process is done. After the meta data stored in the first meta-data storage are retrieved and processed by the SW decoding part 104, the video decoding process for at least a portion of the current frame (e.g., one frame, one MB, one tile, or one slice) is done, and the meta data stored in the first meta-data storage are no longer needed. In step 314, the controller 202 instructs the storage device 204 to release the first meta-data storage, thereby making the first meta-data storage have a status indicator “available/empty”. Since the storage device 204 has an available meta-data storage (i.e., the first meta-data storage just released), the controller 202 can assign the first meta-data storage to the HW decoding part 102, and triggers the HW decoding part 102 to start the HW decoding for a next frame or to start the HW decoding for a portion of a frame (e.g., the next MB/tile/slice in the current frame or the leading MB/tile/slice in the next frame).

Since the video decoding process is partitioned into HW decoding and subsequent SW decoding, the HW decoding part 102 and the SW decoding part 104 shown in FIG. 2 can be configured to form a decoding pipeline for achieving better decoding performance. Several decoding pipeline designs based on the HW decoding part 102 and the SW decoding part 104 are proposed as below.

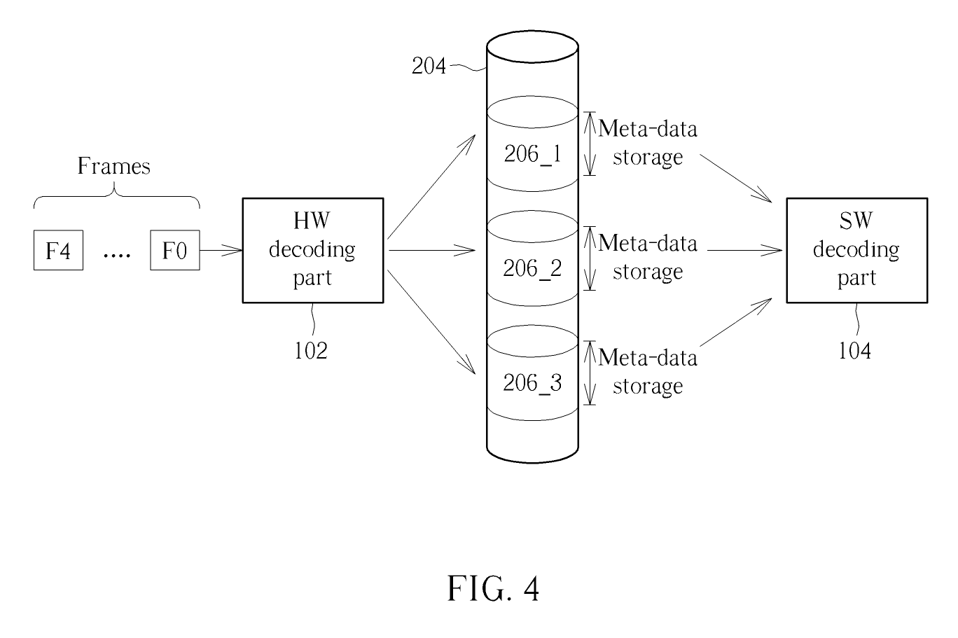

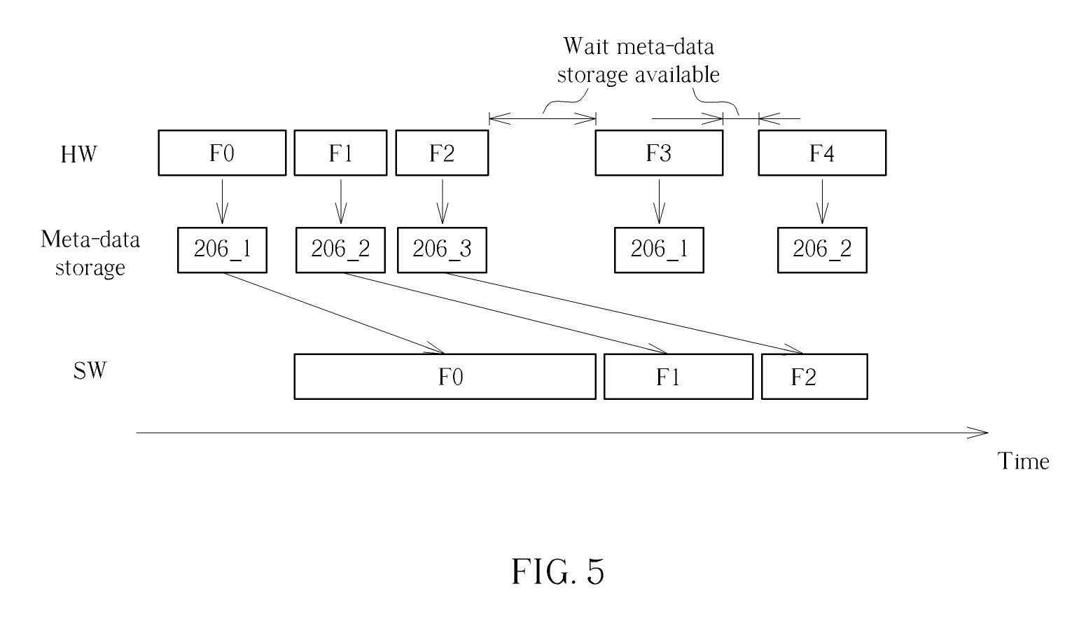

Please refer to FIG. 4 in conjunction with FIG. 5. FIG. 4 is a diagram illustrating a hybrid video decoder with a frame level pipeline according to an embodiment of the present invention. FIG. 5 is a diagram illustrating meta-data storages used by the frame level pipeline according to an embodiment of the present invention. As shown in FIG. 4, successive frames F0-F4 to be decoded by the hybrid video decoder 100 are fed into the HW decoding part 102 one by one. Since the frame level pipeline is formed by the HW decoding part 102 and the SW decoding part 104, the SW decoding part 104 does not start SW decoding of frame F0 until the HW decoding part 102 finishing HW decoding of frame F0, the SW decoding part 104 does not start SW decoding of frame F1 until the HW decoding part 102 finishing HW decoding of frame F1, the SW decoding part 104 does not start SW decoding of frame F2 until the HW decoding part 102 finishing HW decoding of frame F2; the SW decoding part 104 does not start SW decoding of frame F3 until the HW decoding part 102 finishing HW decoding of frame F3; and the SW decoding part 104 does not start SW decoding of frame F4 until the HW decoding part 102 finishing HW decoding of frame F4.

By way of example, but not limitation, it is assumed that the storage 204 has three meta-data storages 206_1-206_3. As shown in FIG. 5, the meta-data storage 206_1 is assigned to the HW decoding part 102 to store the meta data associated with HW decoding of frame F0, the meta-data storage 206_2 is assigned to the HW decoding part 102 to store the meta data associated with HW decoding of frame F1, and the meta-data storage 206_3 is assigned to the HW decoding part 102 to store the meta data associated with HW decoding of frame F2. In this embodiment, the processing time of HW decoding of frame F1 and processing time of HW decoding of frame F2 are overlapped with the processing time of SW decoding of frame F0. Since the SW decoding part 104 finishes SW decoding of frame F0 after the HW decoding part 102 finishes HW decoding of frame F2, there is no available meta-data storage at the time the HW decoding of frame F2 is done. Hence, HW decoding of the next frame F3 cannot be started immediately after the HW decoding of frame F2 is done. After the SW decoding of frame F0 is done, the meta-data storage 206_1 is released and assigned to the HW decoding part 102. At this moment, the HW decoding of frame F3 can be started. In this embodiment, the processing time of HW decoding of frame F3 is overlapped with the processing time of SW decoding of frame F1.

Similarly, since the SW decoding part 104 finishes SW decoding of frame F1 after the HW decoding part 102 finishes HW decoding of frame F3, there is no available meta-data storage at the time the HW decoding of frame F3 is done due to the fact that the meta-data storage 206_2 is an unavailable meta-data storage that still stores certain meta data associated with frame F1 and not processed by SW decoding yet, the meta-data storage 206_3 is an unavailable meta-data storage that still stores certain meta data associated with frame F2 and not processed by SW decoding yet, and the meta-data storage 206_1 is an unavailable meta-data storage that still stores certain meta data associated with frame F3 and not processed by SW decoding yet. Hence, HW decoding of the next frame F4 cannot be started immediately after the HW decoding of frame F3 is done. After the SW decoding of frame F1 is done, the meta-data storage 206_2 is released and assigned to the HW decoding part 102. At this moment, the HW decoding of frame F4 can be started. In this embodiment, the processing time of HW decoding of frame F4 is overlapped with the processing time of SW decoding of frame F2.

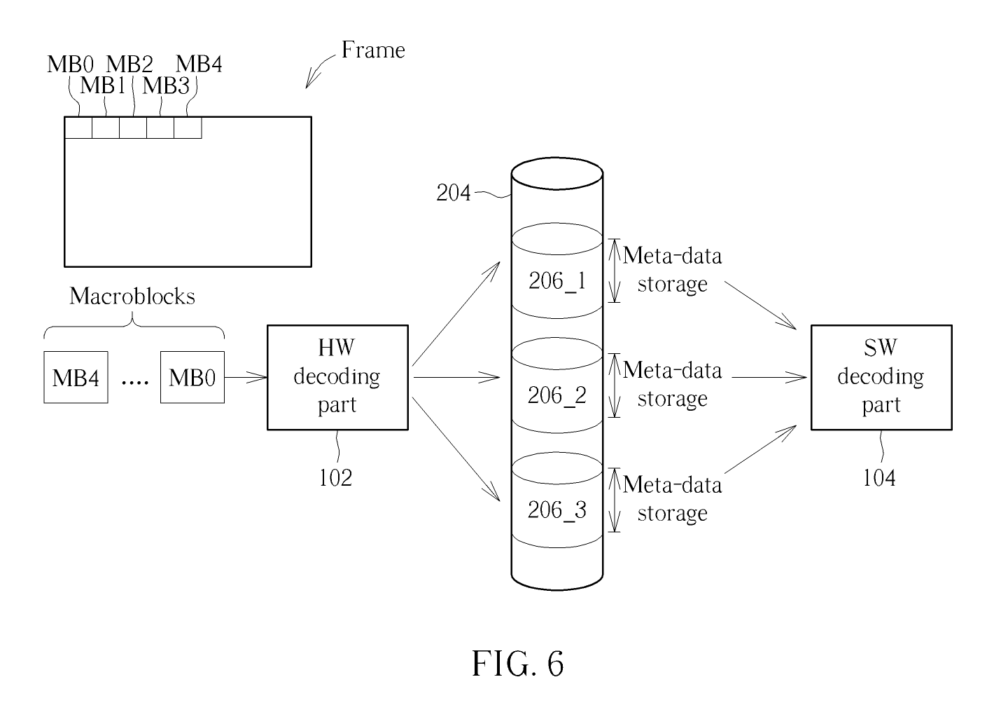

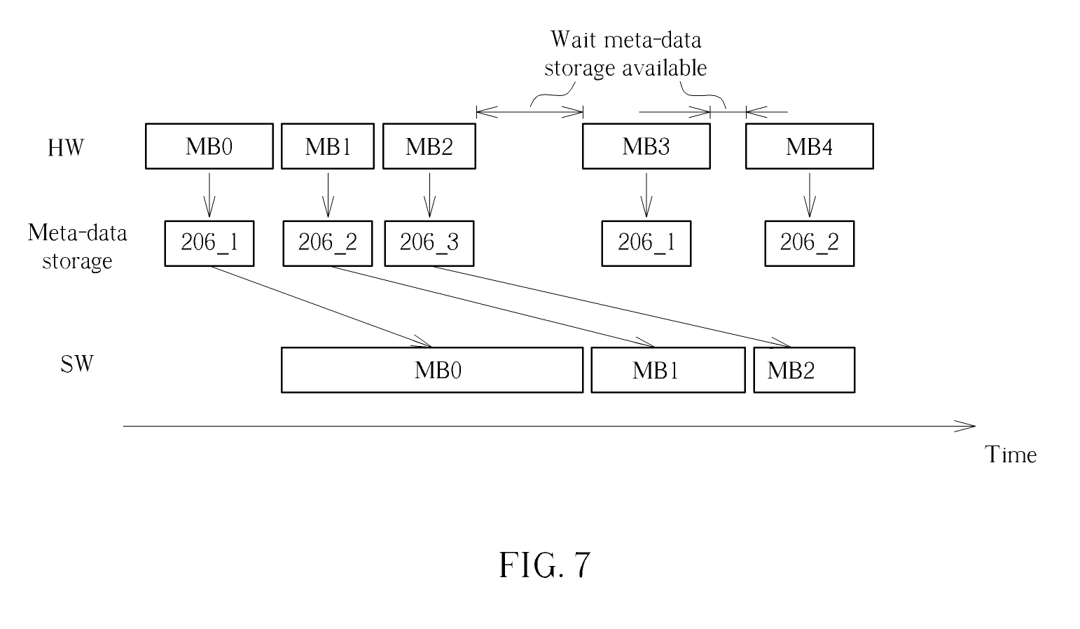

Please refer to FIG. 6 in conjunction with FIG. 7. FIG. 6 is a diagram illustrating a hybrid video decoder with a macroblock (MB) level pipeline according to an embodiment of the present invention. FIG. 7 is a diagram illustrating meta-data storages used by the MB level pipeline according to an embodiment of the present invention. As shown in FIG. 6, successive MBs MB0-MB4 to be decoded by the hybrid video decoder 100 are fed into the HW decoding part 102 one by one. Since the MB level pipeline is formed by the HW decoding part 102 and the SW decoding part 104, the SW decoding part 104 does not start SW decoding of macroblock MB0 until the HW decoding part 102 finishing HW decoding of macroblock MB0, the SW decoding part 104 does not start SW decoding of macroblock MB1 until the HW decoding part 102 finishing HW decoding of macroblock MB1, the SW decoding part 104 does not start SW decoding of macroblock MB2 until the HW decoding part 102 finishing HW decoding of macroblock MB2; the SW decoding part 104 does not start SW decoding of macroblock MB3 until the HW decoding part 102 finishing HW decoding of macroblock MB3; and the SW decoding part 104 does not start SW decoding of macroblock MB4 until the HW decoding part 102 finishing HW decoding of macroblock MB4.

By way of example, but not limitation, it is assumed that the storage 204 has three meta-data storages 206_1-206_3. As shown in FIG. 7, the meta-data storage 206_1 is assigned to the HW decoding part 102 to store the meta data associated with HW decoding of macroblock MB0, the meta-data storage 206_2 is assigned to the HW decoding part 102 to store the meta data associated with HW decoding of macroblock MB1, and the meta-data storage 206_3 is assigned to the HW decoding part 102 to store the meta data associated with HW decoding of macroblock MB2. In this embodiment, the processing time of HW decoding of macroblock MB1 and processing time of HW decoding of macroblock MB2 are overlapped with the processing time of SW decoding of macroblock MB0. Since the SW decoding part 104 finishes SW decoding of macroblock MB0 after the HW decoding part 102 finishes HW decoding of macroblock MB2, there is no available meta-data storage at the time the HW decoding of macroblock MB2 is done. Hence, HW decoding of the next macroblock MB3 cannot be started immediately after the HW decoding of macroblock MB2 is done. After the SW decoding of macroblock MB0 is done, the meta-data storage 206_1 is released and assigned to the HW decoding part 102. At this moment, the HW decoding of macroblock MB3 can be started. In this embodiment, the processing time of HW decoding of macroblock MB3 is overlapped with the processing time of SW decoding of macroblock MB1.

Similarly, since the SW decoding part 104 finishes SW decoding of macroblock MB1 after the HW decoding part 102 finishes HW decoding of macroblock MB3, there is no available meta-data storage at the time the HW decoding of macroblock MB3 is done due to the fact that the meta-data storage 206_2 is an unavailable meta-data storage that still stores certain meta data associated with macroblock MB1 and not processed by SW decoding yet, the meta-data storage 206_3 is an unavailable meta-data storage that still stores certain meta data associated with macroblock MB2 and not processed by SW decoding yet, and the meta-data storage 206_1 is an unavailable meta-data storage that still stores certain meta data associated with macroblock MB3 and not processed by SW decoding yet. Hence, HW decoding of the next macroblock MB4 cannot be started immediately after the HW decoding of macroblock MB3 is done. After the SW decoding of macroblock MB1 is done, the meta-data storage 206_2 is released and assigned to the HW decoding part 102. At this moment, the HW decoding of macroblock MB4 can be started. In this embodiment, the processing time of HW decoding of macroblock MB4 is overlapped with the processing time of SW decoding of macroblock MB2.

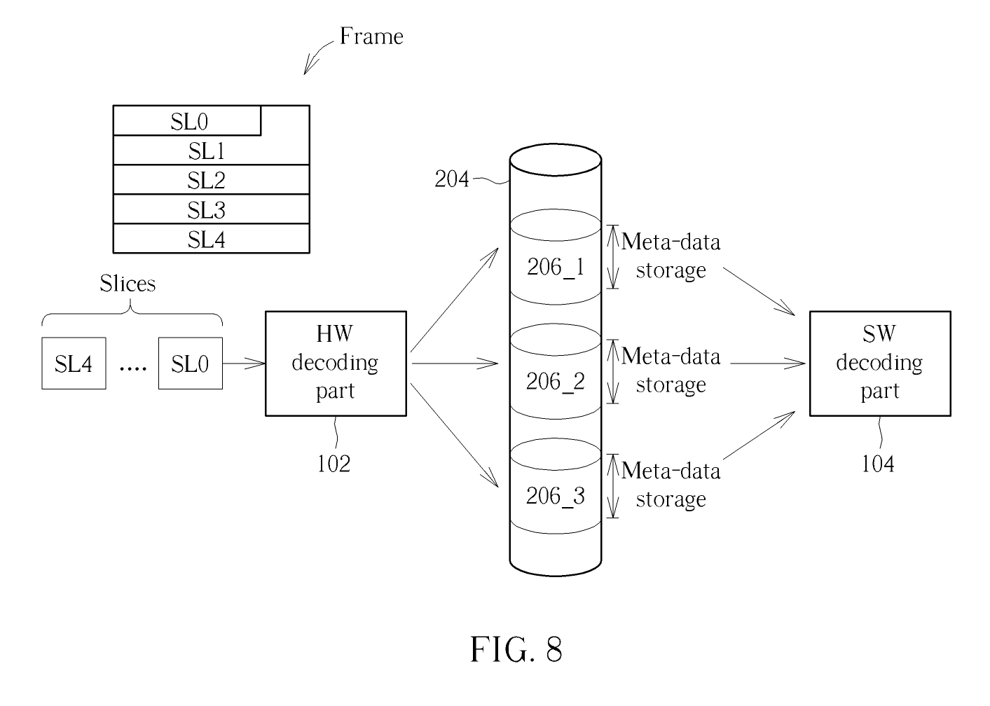

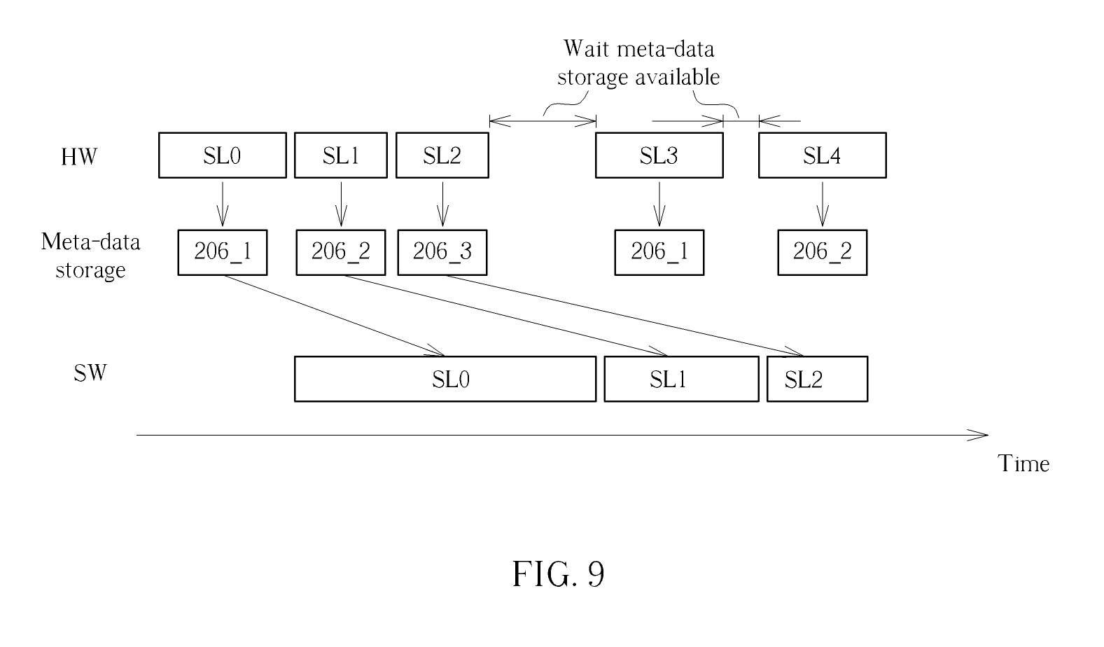

Please refer to FIG. 8 in conjunction with FIG. 9. FIG. 8 is a diagram illustrating a hybrid video decoder with a slice level pipeline according to an embodiment of the present invention. FIG. 9 is a diagram illustrating meta-data storages used by the slice level pipeline according to an embodiment of the present invention. As shown in FIG. 8, successive slices SL0-SL4 to be decoded by the hybrid video decoder 100 are fed into the HW decoding part 102 one by one. Since the slice level pipeline is formed by the HW decoding part 102 and the SW decoding part 104, the SW decoding part 104 does not start SW decoding of slice SL0 until the HW decoding part 102 finishing HW decoding of slice SL0, the SW decoding part 104 does not start SW decoding of slice SL1 until the HW decoding part 102 finishing HW decoding of slice SL1, the SW decoding part 104 does not start SW decoding of slice SL2 until the HW decoding part 102 finishing HW decoding of slice SL2; the SW decoding part 104 does not start SW decoding of slice SL3 until the HW decoding part 102 finishing HW decoding of slice SL3; and the SW decoding part 104 does not start SW decoding of slice SL4 until the HW decoding part 102 finishing HW decoding of slice SL4.

By way of example, but not limitation, it is assumed that the storage 204 has three meta-data storages 206_1-206_3. As shown in FIG. 9, the meta-data storage 206_1 is assigned to the HW decoding part 102 to store the meta data associated with HW decoding of slice SL0, the meta-data storage 206_2 is assigned to the HW decoding part 102 to store the meta data associated with HW decoding of slice SL1, and the meta-data storage 206_3 is assigned to the HW decoding part 102 to store the meta data associated with HW decoding of slice SL2. In this embodiment, the processing time of HW decoding of slice SL1 and processing time of HW decoding of slice SL2 are overlapped with the processing time of SW decoding of slice SL0. Since the SW decoding part 104 finishes SW decoding of slice SL0 after the HW decoding part 102 finishes HW decoding of slice SL2, there is no available meta-data storage at the time the HW decoding of slice SL2 is done. Hence, HW decoding of the next slice SL3 cannot be started immediately after the HW decoding of slice SL2 is done. After the SW decoding of slice SL0 is done, the meta-data storage 206_1 is released and assigned to the HW decoding part 102. At this moment, the HW decoding of slice SL3 can be started. In this embodiment, the processing time of HW decoding of slice SL3 is overlapped with the processing time of SW decoding of slice SL1.

Similarly, since the SW decoding part 104 finishes SW decoding of slice SL1 after the HW decoding part 102 finishes HW decoding of slice SL3, there is no available meta-data storage at the time the HW decoding of slice SL3 is done due to the fact that the meta-data storage 206_2 is an unavailable meta-data storage that still stores certain meta data associated with slice SL1 and not processed by SW decoding yet, the meta-data storage 206_3 is an unavailable meta-data storage that still stores certain meta data associated with slice SL2 and not processed by SW decoding yet, and the meta-data storage 206_1 is an unavailable meta-data storage that still stores certain meta data associated with slice SL3 and not processed by SW decoding yet. Hence, HW decoding of the next slice SL4 cannot be started immediately after the HW decoding of slice SL3 is done. After the SW decoding of slice SL1 is done, the meta-data storage 206_2 is released and assigned to the HW decoding part 102. Hence, the HW decoding of slice SL4 is started after the SW decoding of slice SL1 is done. In this embodiment, the processing time of HW decoding of slice SL4 is overlapped with the processing time of SW decoding of slice SL2.

In above embodiments, the storage device 204 is configured to have multiple meta-data storages (e.g., 206_1-206_3) allocated therein. Alternatively, the storage device 204 may be configured to have only one meta-data storage allocated therein, such that the single meta-data storage is shared by the HW decoding part 102 for HW decoding of any frame and the SW decoding part 104 for SW decoding of any frame. As mentioned above, the storage device 204 may be implemented by a single storage unit or multiple storage units. Hence, the single meta-data storage may be allocated in a single storage unit or multiple storage units.

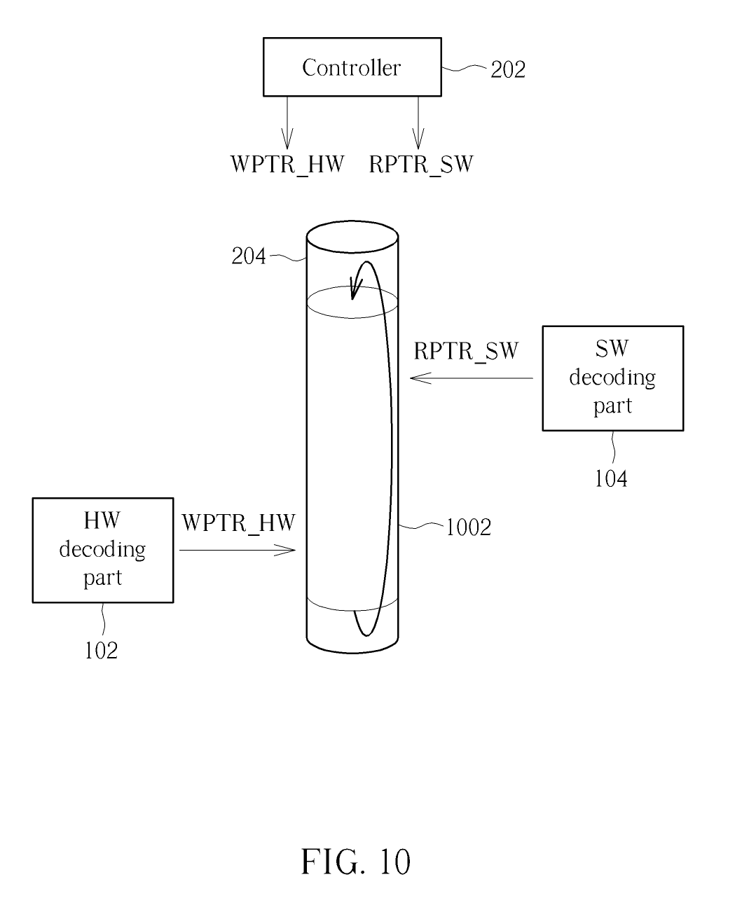

In one exemplary design, the aforementioned single meta-data storage may be configured to act as a ring buffer. FIG. 10 is a diagram illustrating a hybrid video decoder with a single meta-data storage shared by a hardware decoding part for hardware decoding of any frame and a software decoding part for software decoding of any frame according to an embodiment of the present invention. The storage device 204 has only one meta-data storage 1002 allocated therein. For example, the meta-data storage 1002 may act as a ring buffer for storing the meta data generated from the HW decoding part 102 and providing the stored meta data to the SW decoding part 104. Hence, due to inherent characteristics of a ring buffer, the meta-data storage 1002 may be regarded as a meta-data storage with a large storage capability. In this embodiment, the controller 202 is arranged to maintain a write pointer WPTR_HW and a read pointer RPTR_SW. The HW decoding part 102 and the SW decoding part 104 operate in a racing mode. For example, the HW decoding part 102 writes the meta data into the meta-data storage 1002 according to the write pointer WPTR_HW, where the write pointer WPTR_HW is updated each time new meta data is written into the meta-data storage 1002; and the SW decoding part 104 reads the stored meta data from the meta-data storage 1002 according to the read pointer RPTR_SW, where the read pointer RPTR_SW is updated each time old meta data is read from the meta-data storage 1002. Hence, the HW decoding part 102 writes the meta data into the meta-data storage 1002, and the SW decoding part 104 races to parse and process the stored meta data in the meta-data storage 1002. It should be noted that the write pointer WPTR_HW should be prevented from passing the read pointer RPTR_SW to avoid overwriting the meta data that are not read out yet, and the read pointer RPTR_SW should be prevented from passing the write pointer WPTR_HW to avoid reading incorrect data. In a case where the write pointer WPTR_HW catches up or is close to the read pointer RPTR_SW, the HW decoding part 102 may be instructed to stop outputting the meta data to the meta-data storage 1002. In another case where the read pointer RPTR_SW catches up or is close to the write pointer WPTR_HW, the SW decoding part 104 may be instructed to stop retrieving the meta data from the meta-data storage 1002. However, these are for illustrative purposes only, and are not meant to be limitations of the present invention. For example, a hybrid video decoder with only one meta-data storage accessible to a hardware decoding part and a software decoding part falls within the scope of the present invention.

When a pipeline of HW decoding and SW decoding is employed by a hybrid video decoder, each meta-data storage may be configured to be large enough to accommodate all meta data associated with at least a portion of a frame (e.g., one frame, one MB, one tile, or one slice) that is a basic process unit of the pipeline. For example, concerning the aforementioned frame level pipeline shown in FIG. 4, each of the meta-data storages 206_1-206_3 may be configured to be large enough to accommodate all meta data associated with any frame. For another example, concerning the aforementioned MB level pipeline shown in FIG. 6, each of the meta-data storages 206_1-206_3 may be configured to be large enough to accommodate all meta data associated with any macroblock. For yet another example, concerning the aforementioned slice level pipeline shown in FIG. 8, each of the meta-data storages 206_1-206_3 may be configured to be large enough to accommodate all meta data associated with any slice. However, for a real application, a required size of one meta-data storage is unknown before the actual bitstream parsing. Hence, to ensure that all meta data associated with one basic process unit of the pipeline (e.g., one frame, one MB, one tile, or one slice) can be stored into a meta-data storage, the meta-data storage may be intentionally configured to have a large size, thus resulting in higher production cost inevitably. To solve this problem, the present invention therefore proposes using a modified meta-data storage which is not large enough to accommodate all meta data associated with at least a portion of a frame (e.g., one frame, one MB, one tile, or one slice) that is a basic process unit of a pipeline.

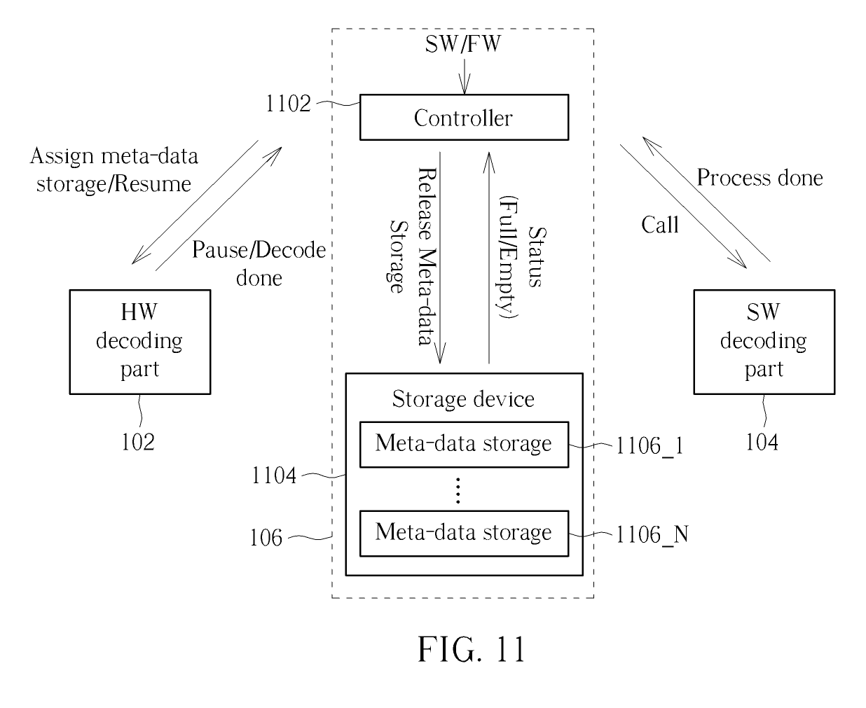

FIG. 11 is a diagram illustrating a second exemplary design of the meta-data access system 106 shown in FIG. 1 according to an embodiment of the present invention. In this embodiment, the meta-data access system 106 includes a controller 1102 and a storage device 1104. By way of example, but not limitation, the controller 1102 may load and execute software SW or firmware FW to achieve the intended functionality. The storage device 1104 is arranged to store meta data transferred between the hardware (HW) decoding part 102 and the software (SW) decoding part 104 of the hybrid video decoder 100. In addition to a “Decode done” signal, a “Pause” signal may be conditionally generated from the HW decoding part 102 to the controller 1102. In addition to an “Assign meta-data storage” command, a “Resume” command may be conditionally generated from the controller 1102 to the HW decoding part 102.

The storage device 1104 may be implemented using a single storage unit (e.g., a single memory device), or may be implemented using multiple storage units (e.g., multiple memory devices). In other words, a storage space of the storage device 1104 may be a storage space of a single storage unit, or may be a combination of storage spaces of multiple storage units. In addition, the storage device 1104 may be an internal storage device such as a static random access memory (SRAM) or flip-flops, may be an external storage device such as a dynamic random access memory (DRAM), a flash memory, or a hard disk, or may be a mixed storage device composed of internal storage device(s) and external storage device(s). In this embodiment, the storage space of the storage device 1104 may be configured to have one or more meta-data storages 1106_1-1106_N allocated therein, where N is a positive integer and N≧1. Each of the meta-data storages 1106_1-1106_N does not need to be large enough to accommodate all meta data associated with at least a portion of a frame (e.g., one frame, one MB, one tile, or one slice) that is a basic process unit of a pipeline.

Each of the meta-data storages 1106_1-1106_N has an associated status indicator indicating whether the meta-data storage is available (e.g., empty) or unavailable (e.g., full). When a status indicator indicates that an associated meta-data storage is available (e.g., empty), it means the associated meta-data storage can be used by the HW decoding part 102. When the status indicator indicates that the associated meta-data storage is unavailable (e.g., full), it means the associated meta-data storage is already written by the HW decoding part 102 to have meta data needed to be processed by the SW decoding part 104, and is not available to the HW decoding part 102 for storing more HW generated meta data.

The controller 1102 is arranged to manage the storage space of the storage device 1104 according to at least one of an operation status of the hardware decoding part 102 and an operation status of the software decoding part 104. In this embodiment, the controller 1102 is able to receive a “Decode done” signal from the HW decoding part 102, receive a “Pause” signal from the HW decoding part 102, receive a “Process done” signal from the SW decoding part 104, generate an “Assign meta-data storage” command to assign an available meta-data storage to the HW decoding part 102, generate a “Resume” command to instruct the HW decoding part 102 to resume HW decoding, generate a “Call” command to trigger the SW decoding part 104 to start SW decoding, and generate a “Release meta-data storage” command to the storage device 1104 to make an unavailable meta-data storage with a status indicator “unavailable/full” become an available meta-data storage with a status indicator “available/empty”.

The controller 1102 is capable of monitoring a status indicator of each meta-data storage allocated in the storage device 1104 to properly manage the storage device 1104 accessed by the HW decoding part 102 and the SW decoding part 104. Further details of the controller 1102 are described as below.

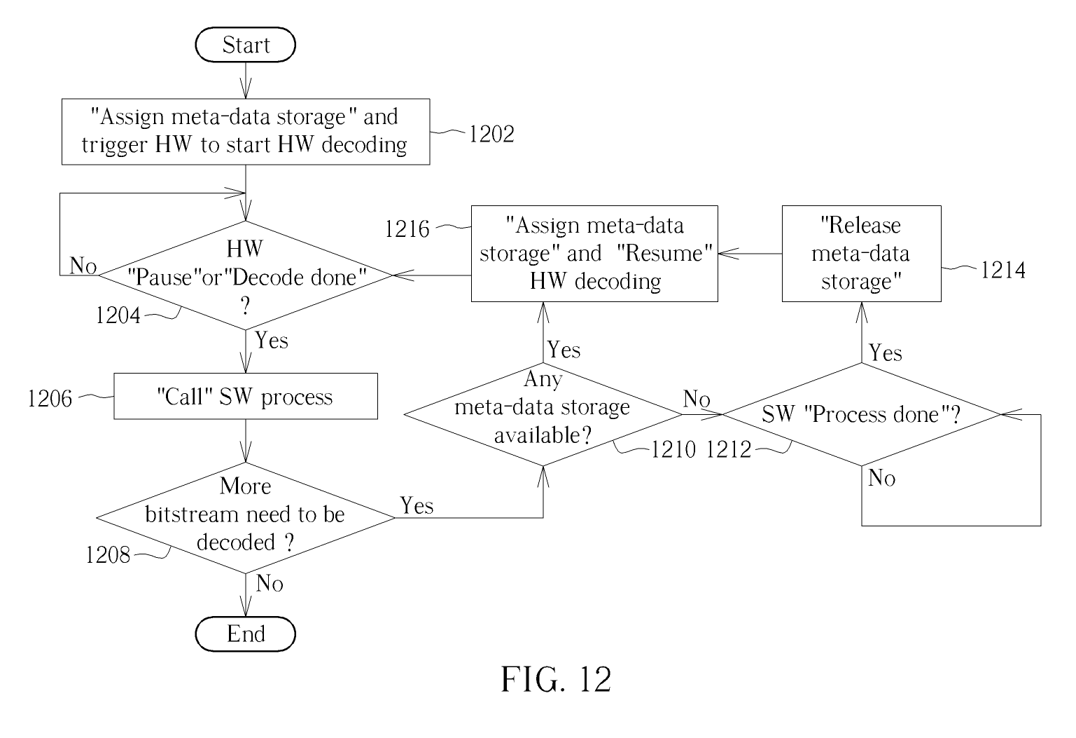

FIG. 12 is a flowchart illustrating a control method employed by the controller 1102 in FIG. 11 according to an embodiment of the present invention. Provided that the result is substantially the same, the steps are not required to be executed in the exact order shown in FIG. 12. Initially, each of the meta-data storages 1106_1-1106_N (N≧1) allocated in the storage device 1104 has a status indicator “available/empty”. Hence, in step 1202, the controller 1102 assigns a first meta-data storage (which is an available meta-data storage selected from meta-data storages 1106_1-1106_N) to the HW decoding part 102, and triggers the HW decoding part 102 to start the HW decoding (i.e., first portion of video decoding process) for at least a portion of a current frame (e.g., one frame, one MB, one tile, or one slice). After the first portion of the video decoding process is started, the HW decoding part 102 generates the meta data to the first meta-data storage assigned by the controller 1102. Since each of the meta-data storages 1106_1-1106_N is not guaranteed to have a storage space sufficient for accommodating all meta data associated with at least a portion of a frame (e.g., one frame, one MB, one tile, or one slice), it is possible that the first meta-data storage assigned to the HW decoding part 102 is full before the first portion of the video decoding process for at least a portion of the current frame (e.g., one frame, one MB, one tile, or one slice) is done, and the HW decoding part 102 generates a “Pause” signal correspondingly. In step 1204, the controller 1102 checks if the first portion of the video decoding process is done or paused. For example, the controller 1102 checks if a “Decode done” signal or a “Pause” signal is generated by the HW decoding part 102. If one of the “Decode done” signal and the “Pause” signal is received by the controller 1102, the flow proceeds with step 1206; otherwise, the controller 1102 keeps checking if the first portion of the video decoding process is done or paused. It should be noted that, when the first portion of the video decoding process is performed or after the first portion of the video decoding process is done/paused, the first meta-data storage assigned by the controller 1102 is set to have a status indicator “unavailable/full”. That is, since the first meta-data storage has the meta data waiting to be processed by the subsequent SW decoding, the first meta-data storage becomes an unavailable meta-data storage for the controller 1102.

In step 1206, the controller 1102 instructs the SW decoding part 104 to start the subsequent SW decoding (i.e., second portion of video decoding process) of the meta data stored in the first meta-data storage. Hence, the HW generated meta data in the first meta-data storage are read by the SW decoding part 104 and processed by the subsequent SW decoding at the SW decoding part 104. It should be noted that step 1206 is a task that can be executed at any timing in the flowchart when the meta data in one meta-data storage are ready for subsequent SW decoding.

In step 1208, the controller 1102 checks if there are more bitstream data (e.g., the rest of at least a portion of the current frame) needed to be decoded. If no, the decoding of at least a portion of the current frame (e.g., one frame, one MB, one tile, or one slice) is ended; otherwise, the flow proceeds with step 1210. For example, when step 1204 determines that a “Decode done” signal is generated by the HW decoding part 102, it implies that the first meta-data storage assigned to the HW decoding part 102 is not full before the first portion of the video decoding process for at least a portion of the current frame (e.g., one frame, one MB, one tile, or one slice) is done. Hence, step 1208 decides that the whole video decoding process, including HW decoding and SW decoding, for at least a portion of the current frame (e.g., one frame, one MB, one tile, or one slice) is done. However, when step 1204 determines that a “Pause” signal is generated by the HW decoding part 102, it implies that the first meta-data storage assigned to the HW decoding part 102 is full before the first portion of the video decoding process for at least a portion of the current frame (e.g., one frame, one MB, one tile, or one slice) is done. Hence, step 1208 decides that the whole video decoding process, including HW decoding and SW decoding, for at least a portion of the current frame (e.g., one frame, one MB, one tile, or one slice) is not done yet, and the flow proceeds with step 1210.

In step 1210, the controller 1102 checks if the storage device 1104 has any meta-data storage with a status indicator “available/empty”. If yes, the flow proceeds with step 1216, and the controller 1102 assigns a second meta-data storage (which is an available meta-data storage selected from meta-data storages 1106_1-1106_N) to the HW decoding part 102, and triggers the HW decoding part 102 to resume the HW decoding (i.e., first portion of video decoding process) for the rest of at least a portion of the current frame.

If step 1210 finds that the storage device 1104 has no meta-data storage with a status indicator “available/empty” now, the flow proceeds with step 1212. In step 1212, the controller 1102 checks if the second portion of the video decoding process performed based on the meta data stored in the first meta-data storage is done. For example, the controller 1102 checks if a “Process done” signal is generated by the SW decoding part 104. If the “Process done” signal is received by the controller 1102, the flow proceeds with step 1214; otherwise, the controller 1102 keeps checking if the second portion of the video decoding process performed upon the meta data stored in the first meta-data storage is done. After the meta data stored in the first meta-data storage are retrieved and processed by the SW decoding part 104, the video decoding process for the meta data stored in the first meta-data storage is done, and the meta data stored in the first meta-data storage are no longer needed. In step 1214, the controller 1102 instructs the storage device 1104 to release the first meta-data storage, thereby making the first meta-data storage have a status indicator “available/empty”. Since the storage device 1104 has an available meta-data storage (i.e., the first meta-data storage just released), the controller 1102 assigns the first meta-data storage to the HW decoding part 102, and triggers the HW decoding part 102 to resume the HW decoding (i.e., first portion of video decoding process) for the rest of at least a portion of the current frame.

Since the video decoding process is partitioned into HW decoding and subsequent SW decoding, the HW decoding part 102 and the SW decoding part 104 shown in FIG. 11 can be configured to form a decoding pipeline for achieving better decoding performance. In this embodiment, each meta-data storage is not guaranteed to have a storage space sufficient for accommodating all meta data associated with one basic pipeline process unit (e.g., one frame, one MB, one tile, or one slice). When a currently used meta-data storage is full and there is at least one available meta-data storage, the HW decoding part 102 may switch from the current meta-data storage to an available meta-data storage to continue the HW decoding of one basic pipeline process unit. When a currently used meta-data storage is full and there is no available meta-data storage, the HW decoding part 102 may pause the HW decoding of one basic pipeline process unit until one meta-data storage becomes available. Hence, the HW decoding part 102 may switch from the current meta-data storage to an available meta-data storage to resume the HW decoding of one basic pipeline process unit. In conclusion, the HW decoding part 102 may use multiple available meta-data storages to accomplish the HW decoding of one basic pipeline process unit (e.g., one frame, one MB, one tile, or one slice).

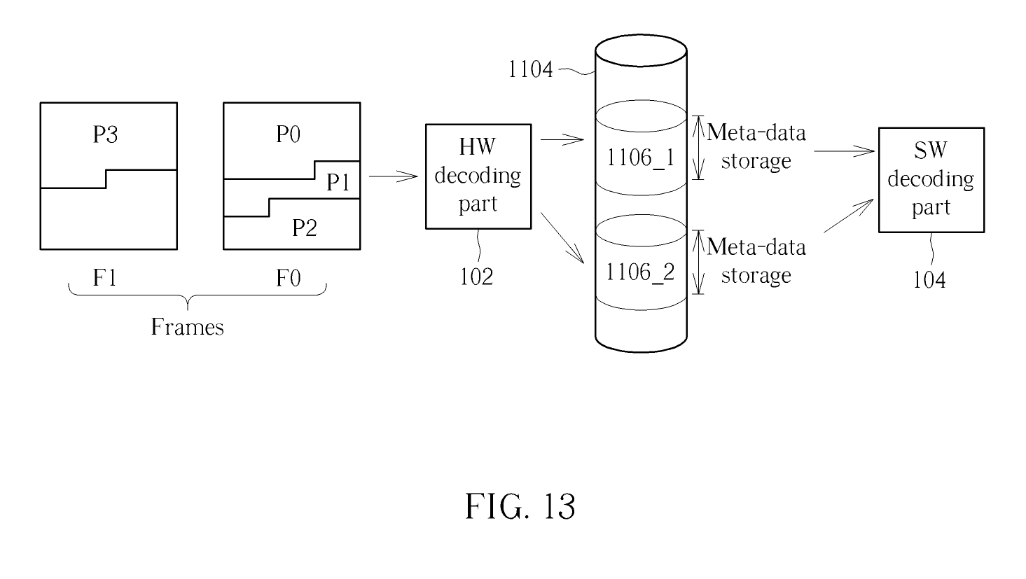

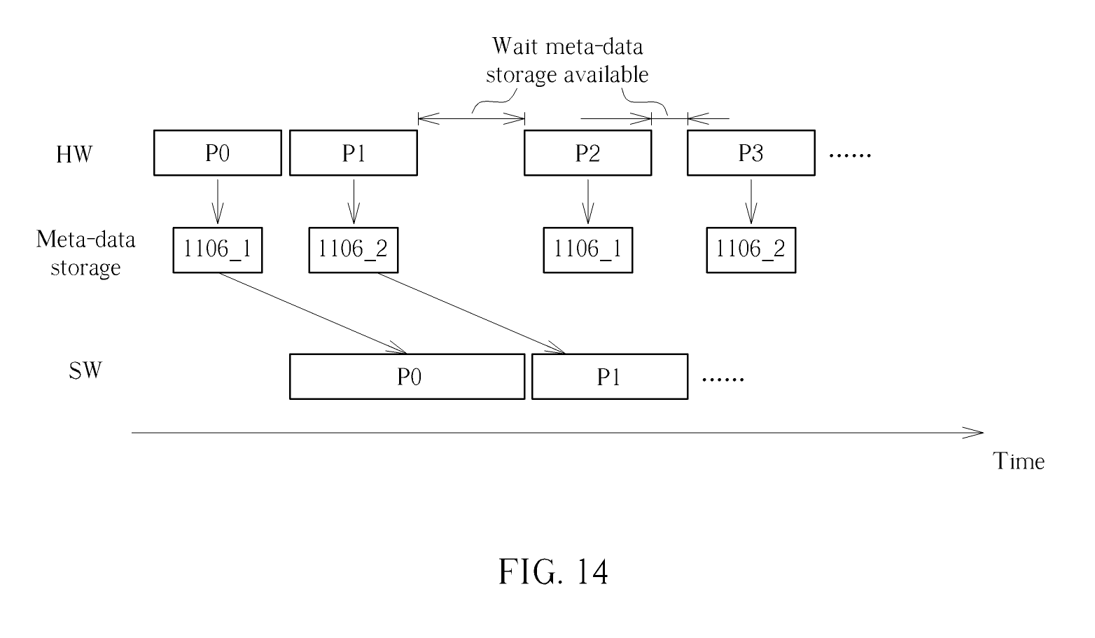

Please refer to FIG. 13 in conjunction with FIG. 14. FIG. 13 is a diagram illustrating a hybrid video decoder with another frame level pipeline according to an embodiment of the present invention. FIG. 14 is a diagram illustrating meta-data storages used by another frame level pipeline according to an embodiment of the present invention. As shown in FIG. 13, successive frames F0 and F1 to be decoded by the hybrid video decoder 100 are fed into the HW decoding part 102 one by one. Since the frame level pipeline is formed by the HW decoding part 102 and the SW decoding part 104, the SW decoding part 104 does not start SW decoding of frame F0 until the HW decoding part 102 finishing HW decoding of frame F0, and the SW decoding part 104 does not start SW decoding of frame F1 until the HW decoding part 102 finishing HW decoding of frame F1.

By way of example, but not limitation, it is assumed that the storage 1104 has two meta-data storages 1106_1 and 1106_2 only. As shown in FIG. 14, the meta-data storage 1106_1 is first assigned to the HW decoding part 102 to store the meta data associated with HW decoding of frame F0. However, after HW decoding of a first part P0 of frame F0 is done, the meta-data storage 1106_1 is full. Hence, the available meta-data storage 1106_2 is assigned to the HW decoding part 102 for storing the following meta data associated with HW decoding of frame F0. In addition, the SW decoding of the meta data stored in the meta-data storage 1106_1 is started.

After HW decoding of a second part P1 of frame F0 is done, the meta-data storage 1106_2 is full. In this embodiment, the processing time of HW decoding of the second part P1 of frame F0 is overlapped with the processing time of SW decoding of first part P0 of frame F0. However, the SW decoding part 104 finishes SW decoding of first part P0 of frame F0 after the HW decoding part 102 finishes HW decoding of second part P1 of frame F0. As a result, there is no available meta-data storage at the time the HW decoding of second part P1 of frame F0 is done. Hence, the HW decoding of a third part P2 of frame F0 cannot be started immediately after the HW decoding of second part P1 of frame F0 is done. After the SW decoding of first part P0 of frame F0 is done, the meta-data storage 1106_1 is released and assigned to the HW decoding part 102. At this moment, the HW decoding of third part P2 of frame F0 can be started. In addition, the SW decoding of second part P1 of frame F0 is started after the SW decoding of first part P0 of frame F0 is done. In this embodiment, the processing time of HW decoding of third part P2 of frame F0 is overlapped with the processing time of SW decoding of second part P1 of frame F0.

Similarly, since the SW decoding part 104 finishes SW decoding of second part P1 of frame F0 after the HW decoding part 102 finishes HW decoding of third part P2 of frame F0, there is no available meta-data storage at the time the HW decoding of third part P2 of frame F0 is done. Hence, the HW decoding of a first part P3 of second frame F1 cannot be started immediately after the HW decoding of the third part P2 of frame F0 is done. After the SW decoding of second part P1 of frame F0 is done, the meta-data storage 1106_2 is released and assigned to the HW decoding part 102. At this moment, the HW decoding of the first part P3 of frame F1 can be started.

In the above embodiment, the storage device 1104 is configured to have multiple meta-data storages (e.g., 1106_1 and 1106_2) allocated therein. Alternatively, the storage device 1104 may be configured to have only one meta-data storage allocated therein, such that the single meta-data storage is shared by the HW decoding part 102 for HW decoding of any frame and the SW decoding part 104 for SW decoding of any frame. As mentioned above, the storage device 1104 may be implemented by a single storage unit or multiple storage units. Hence, the single meta-data storage may be allocated in a single storage unit or multiple storage units.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A hybrid video decoder comprising:
a hardware decoding circuit, arranged to deal with a first portion of a video decoding process for at least a portion of a frame, wherein the first portion of the video decoding process comprises entropy decoding;
a software decoding circuit, arranged to deal with a second portion of the video decoding process; and
a meta-data access system, arranged to manage meta data transferred between the hardware decoding circuit and the software decoding circuit.

2. The hybrid video decoder of claim 1, wherein the meta-data access system comprises:
a storage device, arranged to store the meta data transferred between the hardware decoding circuit and the software decoding circuit; and
a controller, arranged to manage a storage space of the storage device according to at least one of an operation status of the hardware decoding circuit and an operation status of the software decoding circuit.

3. The hybrid video decoder of claim 2, wherein the storage device is configured to have at least a meta-data storage allocated in the storage space, and the meta-data storage is arranged to store the meta data generated from the hardware decoding circuit and provide the stored meta data to the software decoding circuit.

4. The hybrid video decoder of claim 3, wherein the controller assigns the meta-data storage to the hardware decoding circuit and triggers the hardware decoding circuit to start the first portion of the video decoding process.

5. The hybrid video decoder of claim 3, wherein the meta-data storage is large enough to accommodate all meta data associated with said at least a portion of the frame.

6. The hybrid video decoder of claim 5, wherein when notified by the hardware decoding circuit that the first portion of the video decoding process is done, the controller triggers the software decoding circuit to start the second portion of the video decoding process.

7. The hybrid video decoder of claim 6, wherein when notified by the software decoding circuit that the second portion of the video decoding process is done, the controller releases the meta-data storage assigned to the hardware decoding circuit.

8. The hybrid video decoder of claim 3, wherein the meta-data storage is not large enough to accommodate all meta data associated with said at least a portion of the frame.

9. The hybrid video decoder of claim 8, wherein when notified by the hardware decoding circuit that the first portion of the video decoding process is paused due to the meta-data storage is full, the controller triggers the software decoding circuit to start the second portion of the video decoding process.

10. The hybrid video decoder of claim 9, wherein when any meta-data storage in the storage device is available, the controller instructs the hardware decoding circuit to resume the first portion of the video decoding process.

11. The hybrid video decoder of claim 9, wherein when notified by the software decoding circuit that the second portion of the video decoding process is done, the controller releases the meta-data storage assigned to the hardware decoding circuit and instructs the hardware decoding circuit to resume the first portion of the video decoding process.

12. The hybrid video decoder of claim 3, wherein the storage device is configured to have only one meta-data storage allocated therein; the controller maintains a write pointer and a read pointer; the hardware decoding circuit writes the meta data into the only one meta-data storage according to the write pointer; and the software decoding circuit reads the stored meta data from the only one meta-data storage according to the read pointer.

13. A hybrid video decoding method comprising:
performing hardware decoding to deal with a first portion of a video decoding process for at least a portion of a frame, wherein the first portion of the video decoding process comprises entropy decoding;
performing software decoding to deal with a second portion of the video decoding process; and
managing meta data transferred between the hardware decoding and the software decoding.

14. The hybrid video decoding method of claim 13, wherein managing the meta data transferred between the hardware decoding and the software decoding comprises:
storing the meta data transferred between the hardware decoding and the software decoding in a storage device; and
managing a storage space of the storage device according to at least one of an operation status of the hardware decoding and an operation status of the software decoding.

15. The hybrid video decoding method of claim 14, wherein storing the meta data transferred between the hardware decoding and the software decoding in the storage device comprises:
configuring the storage device to have at least a meta-data storage allocated in the storage space; and
utilizing the meta-data storage to store the meta data generated from the hardware decoding and to provide the stored meta data to the software decoding.

16. The hybrid video decoding method of claim 15, wherein managing the storage space of the storage device according to at least one of the operation status of the hardware decoding and the operation status of the software decoding comprises:
assigning the meta-data storage to the hardware decoding; and
triggering the hardware decoding to start the first portion of the video decoding process.

17. The hybrid video decoding method of claim 15, wherein the meta-data storage is large enough to accommodate all meta data associated with said at least a portion of the frame.

18. The hybrid video decoding method of claim 17, wherein managing the storage space of the storage device according to at least one of the operation status of the hardware decoding and the operation status of the software decoding further comprises:
when notified by the hardware decoding that the first portion of the video decoding process is done, triggering the software decoding to start the second portion of the video decoding process.

19. The hybrid video decoding method of claim 18, wherein managing the storage space of the storage device according to at least one of the operation status of the hardware decoding and the operation status of the software decoding further comprises:
when notified by the software decoding that the second portion of the video decoding process is done, releasing the meta-data storage assigned to the hardware decoding.

20. The hybrid video decoding method of claim 15, wherein the meta-data storage is not large enough to accommodate all meta data associated with said at least a portion of the frame.

21. The hybrid video decoding method of claim 20, wherein managing the storage space of the storage device according to at least one of the operation status of the hardware decoding and the operation status of the software decoding further comprises:
when notified by the hardware decoding that the first portion of the video decoding process is paused due to the meta-data storage is full, triggering the software decoding to start the second portion of the video decoding process.

22. The hybrid video decoding method of claim 21, wherein managing the storage space of the storage device according to at least one of the operation status of the hardware decoding and the operation status of the software decoding further comprises:
when any meta-data storage in the storage device is available, instructing the hardware decoding to resume the first portion of the video decoding process.

23. The hybrid video decoding method of claim 21, wherein managing the storage space of the storage device according to at least one of the operation status of the hardware decoding and the operation status of the software decoding further comprises:
when notified by the software decoding that the second portion of the video decoding process is done, releasing the meta-data storage assigned to the hardware decoding, and instructing the hardware decoding to resume the first portion of the video decoding process.

24. The hybrid video decoding method of claim 15, wherein the storage device is configured to have only one meta-data storage allocated therein; and managing the storage space of the storage device according to at least one of the operation status of the hardware decoding and the operation status of the software decoding further comprises:
maintaining a write pointer and a read pointer, wherein the hardware decoding writes the meta data into the only one meta-data storage according to the write pointer; and the software decoding reads the stored meta data from the only one meta-data storage according to the read pointer.
